(19) United States
(12) Patent Application Publication
(10) Pub. No.: US 2025/0362857 A1
(43) Pub. Date: Nov. 27, 2025

(54) SMART ENVIRONMENTAL ADVERTISING SYSTEM

(71) Applicant: Arsalan Peirofeiz, Woodland Hills, CA (US)

(72) Inventor: Arsalan Peirofeiz, Woodland Hills, CA (US)

(21) Appl. No.: 19/290,547

(22) Filed: Aug. 5, 2025

Related U.S. Application Data
(63) Continuation-in-part of application No. 18/581,041, filed on Feb. 19, 2024.

(51) Int. Cl. G06F 3/14; G08G 1/095

(52) U.S. Cl. CPC G06F 3/14; G08G 1/095

(57) ABSTRACT

A smart environmental advertising system may comprise a digital display screen and a mounting structure for attaching the digital display screen in proximity to a traffic signal. The system may include a control unit electrically connected to the digital display screen and to a traffic signal control system. A remote management system may be used for uploading advertising content to the digital display screen. The control unit may be configured to receive signals from the traffic signal control system indicating traffic signal status changes. In response to receiving a signal that the traffic signal has turned red, the control unit may activate the digital display screen to display advertising content. Upon receiving a signal that the traffic signal is turning green, the control unit may deactivate the digital display screen. The system may include additional features such as motion sensors, weatherproofing elements, and audio capabilities. A method for environmental advertising using this system may also be provided.

### CROSS REFERENCE TO RELATED APPLICATIONS

This application claims the benefit of U.S. application Ser. No. 18/581,041, filed on Feb. 19, 2024, which is hereby incorporated by reference in its entirety.

### FIELD OF THE INVENTION

The present invention relates generally to advertising displays and traffic signals. More specifically, the invention relates to methods and apparatus for coordinating advertising displays with traffic signals.

### BACKGROUND

Traffic lights have been widely used for many years to control and coordinate vehicular and pedestrian traffic at intersections. As urban areas have grown more congested, traffic lights have become increasingly important for safety and traffic flow management. However, the time drivers spend waiting at red lights is often viewed as wasted time. Meanwhile, advertising displays are ubiquitous in urban environments, promoting products and services through billboards, store signage, and other means. Advertisers are constantly seeking new ways to reach potential customers.

There have been some attempts to combine advertising with traffic signals, taking advantage of the captive audience of drivers stopped at red lights. However, practical and safety concerns have limited widespread adoption of such systems. Advertising displays could potentially distract drivers from traffic signals, other vehicles, and pedestrians when intersections are at their busiest. The physical location of traffic signals, often over busy streets, also presents challenges for installing and maintaining advertising displays. Therefore, there remains a need for improved systems and methods that can effectively combine advertising displays with traffic signals while addressing safety and practical concerns. An ideal solution would coordinate advertising with traffic signal timing, be unobtrusive, and be easy to install and maintain.

### SUMMARY

The present invention provides methods and apparatus for a smart environmental advertising system that displays advertisements on digital screens coordinated with traffic signals. In one aspect, the invention comprises a weatherproof digital display screen mounted near a traffic signal, a control unit connected to the traffic signal control system, and a remote management system can transfer and display the traffic signals (Red, Green, Yellow, Left Turn, right Turn, Stop, red arrow, green arrow signals or any company ads, etc.) at the same time on a digital HD TV/LCD/LED/Plasma TV which is located near or on the traffic light beam and post, which will make the signals more visible to drivers, because signals are being displayed on the TV as well, and when the light turns red, can display and advertise ads for individuals, governments and businesses.

In some embodiments, the digital display screen is mounted on the same post and beam structure as the traffic signal. In other embodiments, the screen is mounted on a separate post and beam structure within close proximity to the traffic signal. The control unit receives signals from the traffic signal control system and activates the display screen to show advertisements when the traffic signal turns red. When the signal turns green, the control unit immediately deactivates the display. The remote management system allows advertisers and system operators to upload content and manage advertising campaigns across multiple intersections from a central location via the internet.

In some embodiments, the system includes motion sensors or cameras to detect vehicles and pedestrians. This allows the system to activate displays only when potential viewers are present, conserving energy. The invention provides a novel way to reach consumers with targeted advertising while making productive use of wait times at traffic signals. The coordination with signal timing and optional motion sensing capabilities help ensure the system does not create safety hazards.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items. The accompanying drawings, which are incorporated in and constitute a part of this specification, illustrate embodiments of the disclosure and, together with a general description of the disclosure given above, and the detailed description given below, serve to explain the principles of the disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. The present disclosure, in accordance with one or more various embodiments, is described in detail with reference to the following figures. The drawings are provided for purposes of illustration only and merely depict typical or example embodiments of the disclosure. These drawings are provided to facilitate the reader's understanding of the disclosure and shall not be considered limiting of the breadth, scope, or applicability of the disclosure.

FIG. 1 is a diagram showing an overview of a smart environmental advertising system according to an embodiment of the invention.

FIG. 2 is a rear view of an advertising display panel according to an embodiment of the invention.

FIG. 3 is a rear view of a traffic signal post and beam structure with an advertising display panel mounted on the beam according to an embodiment of the invention.

FIG. 4 is a front view of an advertising display panel mounted on a traffic signal beam according to an embodiment of the invention.

FIG. 5 is a side view of a traffic signal post and beam structure with an advertising display panel mounted on the beam according to an embodiment of the invention.

FIG. 6 is a front view of a traffic signal post and beam structure with an advertising display panel mounted on the beam according to an embodiment of the invention.

FIG. 7 is a diagram showing a smart environmental advertising system with the display panel and camera mounted on a separate post and beam structure from the traffic signal according to an embodiment of the invention.

FIG. 8 is a diagram showing connections within the control motherboard of a smart environmental advertising system according to an embodiment of the invention.

FIG. 9 is a diagram showing two traffic signal post and beam structures, with one structure having an advertising display panel mounted and the other structure empty, according to an embodiment of the invention.

FIG. 10 is a diagram similar to FIG. 9 but with the advertising display panel mounted on the second structure according to an embodiment of the invention.

FIG. 11 is a close-up view of an advertising display panel showing an overhanging cover and side panels according to an embodiment of the invention.

FIG. 12 is a top-down view of an advertising display panel mounted on a traffic signal beam according to an embodiment of the invention.

FIG. 13 is a side view of an advertising display panel mounted on a traffic signal beam according to an embodiment of the invention.

FIG. 14 is a side view of a full traffic signal post and beam structure with an advertising display panel mounted on the beam according to an embodiment of the invention.

FIG. 15 is a rear view of an advertising display panel showing air vents and mounting hardware according to an embodiment of the invention.

FIG. 16 is a bottom view of an advertising display panel showing mounting hardware according to an embodiment of the invention.

FIG. 17 is a side end view of an advertising display panel showing mounting hardware according to an embodiment of the invention.

FIG. 18 is a rear view of an advertising display panel showing mounting posts according to an embodiment of the invention.

FIG. 19 is a rear view of a traffic signal post and beam structure with an advertising display panel mounted on the beam according to an embodiment of the invention.

FIG. 20 is a side view of a traffic signal post and beam structure with an advertising display panel as seen from across the street according to an embodiment of the invention.

FIG. 21 is a front view of an advertising display panel according to an embodiment of the invention.

### DETAILED DESCRIPTION

The present invention provides methods and apparatus for a smart environmental advertising system that displays advertisements on digital screens coordinated with traffic signals. The invention will be described in detail with reference to certain preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

Throughout this specification and the claims, the terms “comprise,” “comprising,” “include,” “including,” and the like are to be understood to imply the inclusion of stated elements but not the exclusion of any other elements. The term “exemplary” is used in the sense of “example” rather than “ideal” or “model.” As used herein, the terms “about” or “approximately” apply to all numeric values, whether or not explicitly indicated. These terms generally refer to a range of numbers that one of skill in the art would consider equivalent to the recited values (i.e., having the same function or result).

Before the present articles, systems, apparatuses, and/or methods are disclosed and described, it is to be understood that they are not limited to specific methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

i. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used herein, the terms “about” and “at or about” mean that the amount or value in question can be the value designated some other value approximately or about the same. It is generally understood, as used herein, that it is the nominal value indicated±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise. As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result. The following description of various embodiments is merely exemplary in nature and is in no way intended to limit the disclosure, its application, or uses.

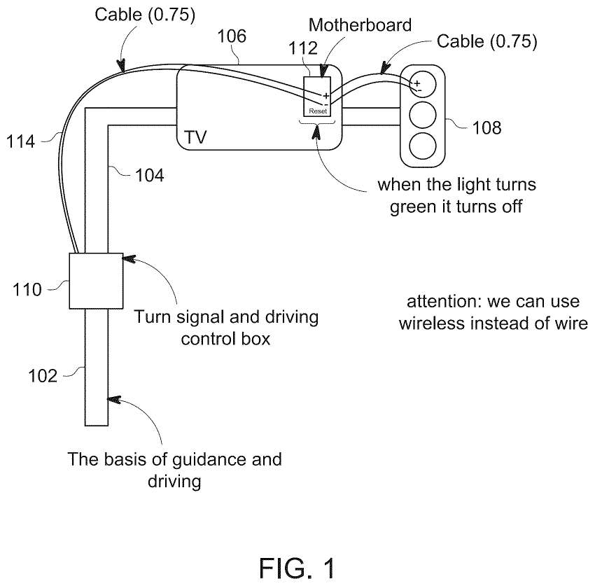

FIG. 1 illustrates an overview of a smart environmental advertising system 100 according to an embodiment of the invention. The system 100 includes a traffic signal post 102 and beam 104. An advertising display panel 106 is mounted on the beam 104 alongside a traffic signal 108. A signal control box 110 is mounted on the post 102. A control motherboard 112 is attached to the advertising display panel 106 and is connected via wires 114 to the traffic signal 108 and signal control box 110. This allows the advertising display panel 106 to be activated when the traffic signal 108 turns red and deactivated when it turns green. While wired connections are shown, in some embodiments wireless connections may be used instead.

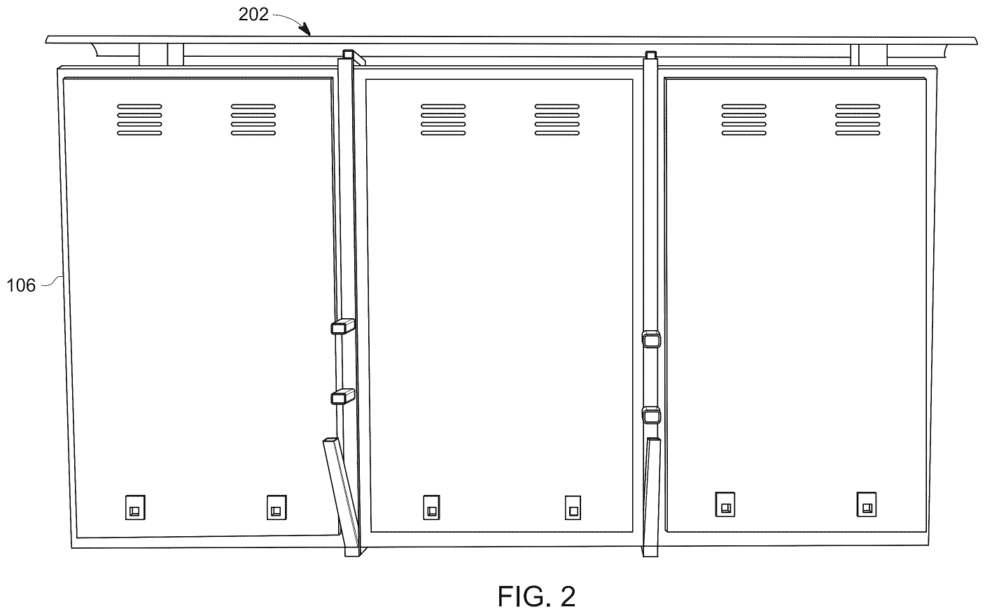

FIG. 2 shows a rear view of the advertising display panel 106. The panel 106 includes mounting hardware 202 for attaching it to the traffic signal beam.

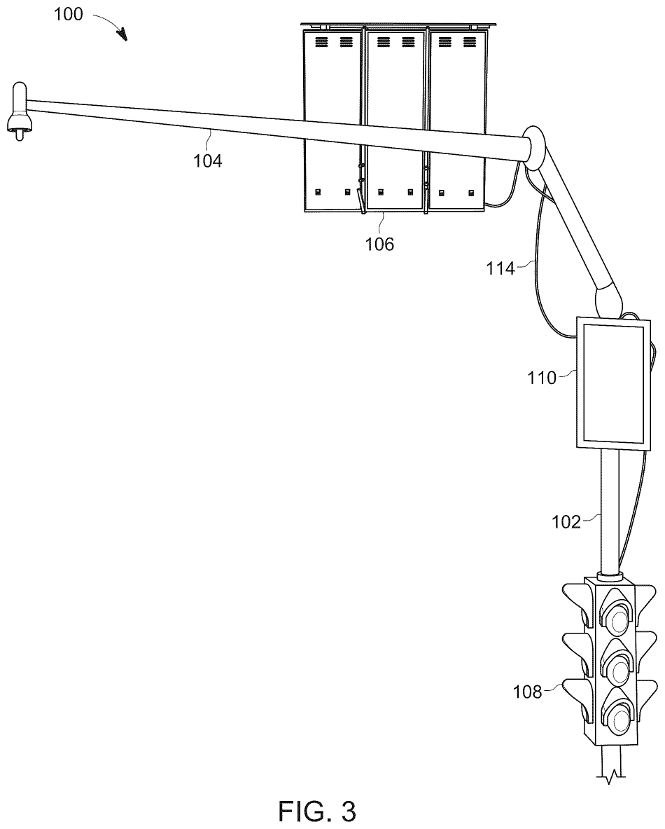

FIG. 3 illustrates a rear view of the entire traffic signal post 102 and beam 104 structure. The advertising display panel 106 is attached to the beam 104. The signal control box 110 and traffic signal 108 are mounted on the post 102, with the signal control box 110 positioned between the traffic signal 108 and advertising display panel 106. Wires 114 connect the advertising display panel 106 to the traffic signal 108 and signal control box 110.

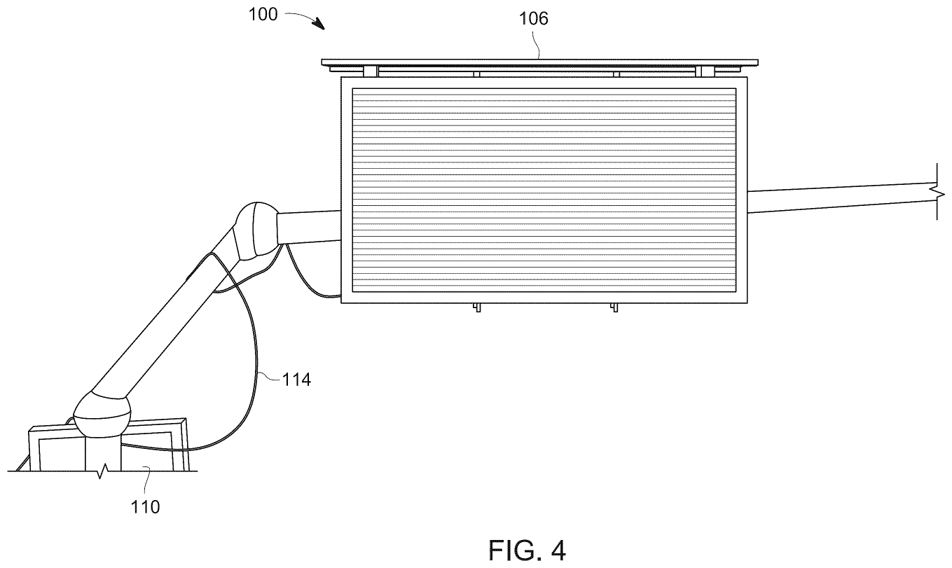

FIG. 4 shows a front view of the advertising display panel 106 mounted on the beam 104. A portion of the signal control box 110 is visible. While wires 114 are shown connecting the signal control box 110 to the advertising display panel 106, in some embodiments these connections may be wireless.

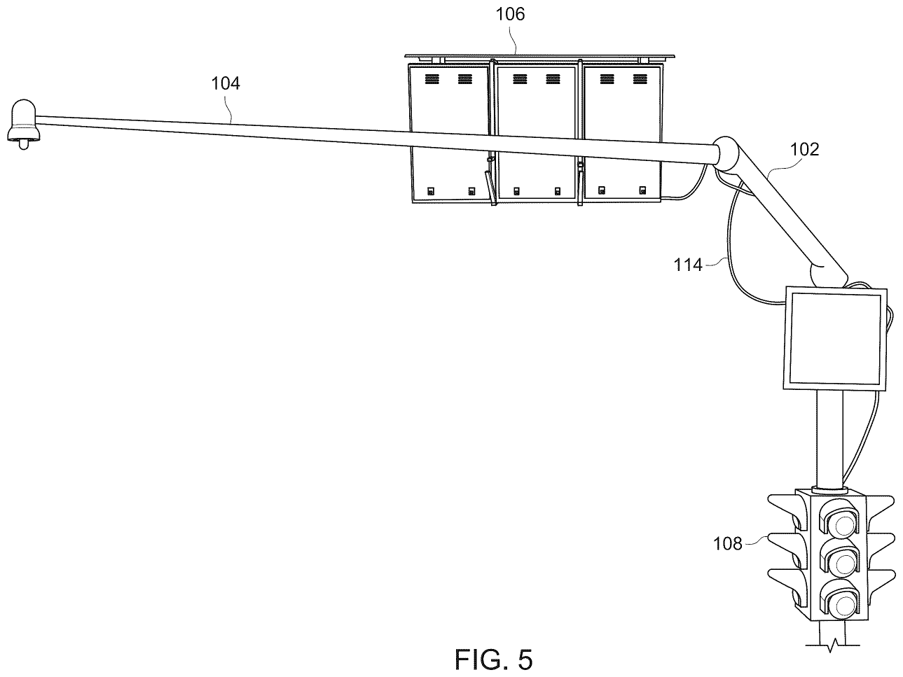

FIG. 5 illustrates a side view of the entire post 102 and beam 104 structure. The rear of the advertising display panel 106 is visible on the beam 104. The traffic signal 108 and signal control box 110 are mounted on the post 102. Wires 114 connect the advertising display panel 106 to the signal control box 110 and traffic signal 108, though these connections may be wireless in some embodiments.

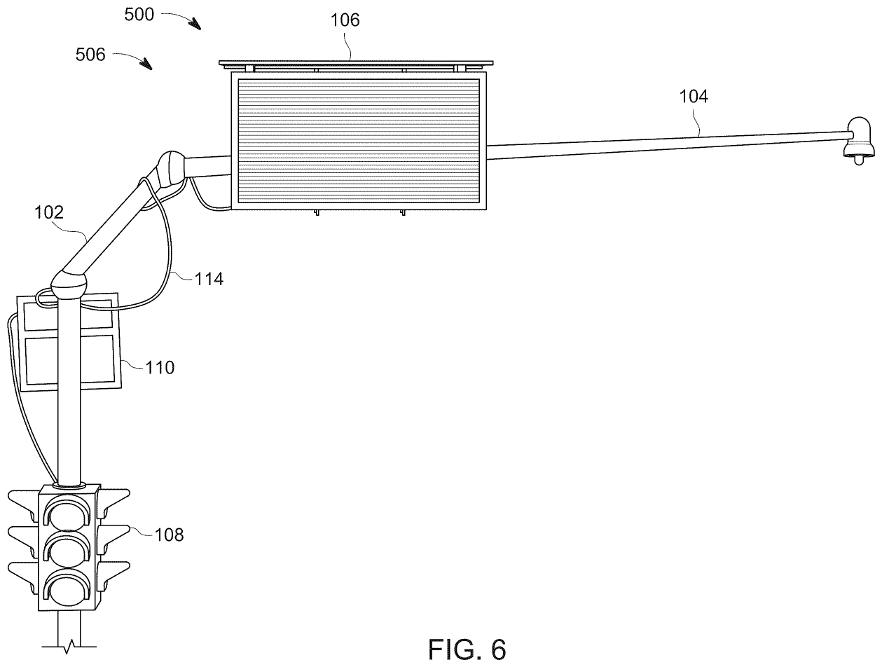

FIG. 6 shows a front view of the entire post 102 and beam 104 structure. The front of the advertising display panel 106 is visible on the beam 104. The rear of the signal control box 110 and front of the traffic signal 108 are visible on the post 102. The traffic signal 108 is showing a red light, indicating that advertisements would be displayed on the advertising panel 106 at this time.

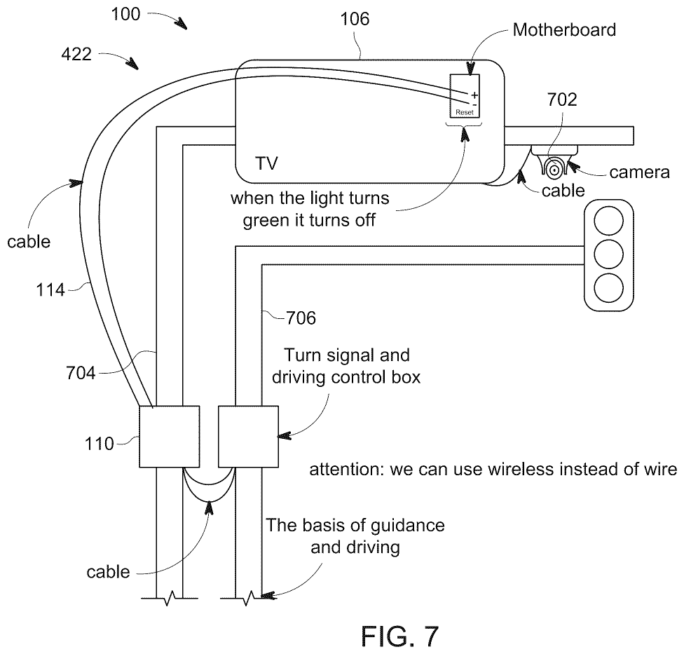

FIG. 7 illustrates an alternative embodiment where the advertising display panel 106 and a camera 702 are mounted on a separate post 704 and beam 706 structure parallel to the traffic signal structure. The advertising display panel 106 is connected via wires 114 to the signal control box 110 to coordinate display timing with the traffic signal. The advertising display panel 106 is also connected to the camera 702, which can detect pedestrians or vehicles and signal the panel to pause advertisements when the crosswalk is in use.

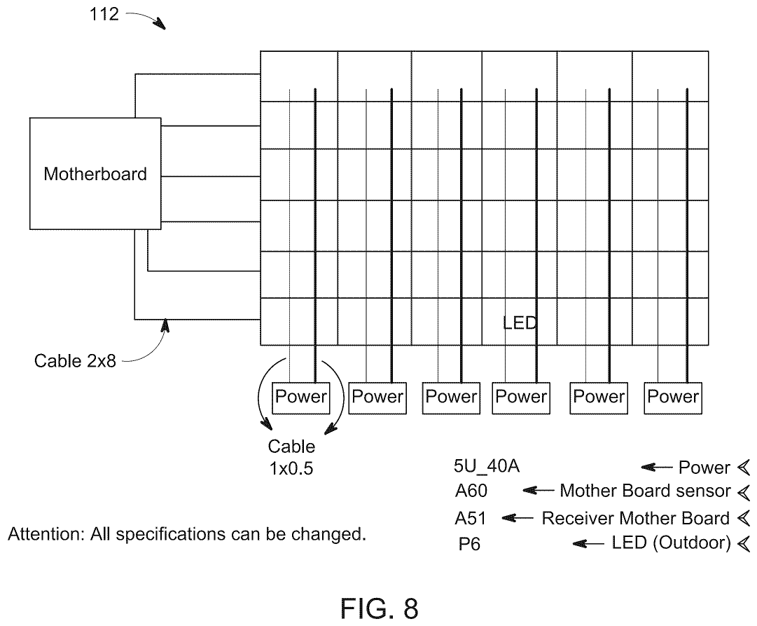

FIG. 8 shows the internal connections of the control motherboard 112. The motherboard 112 manages the coordination between the traffic signal, camera (if present), and advertising display panel.

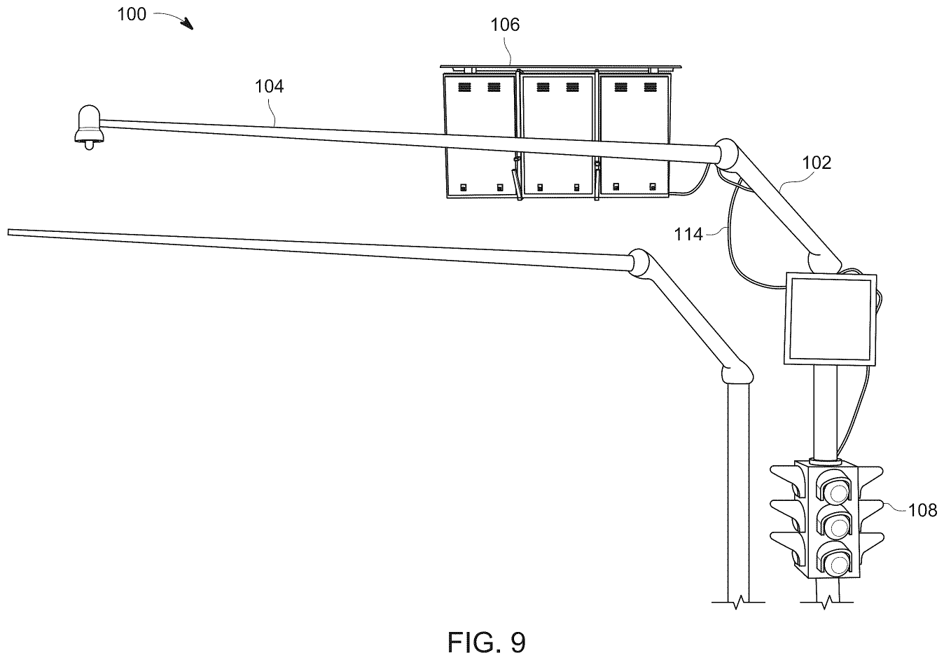

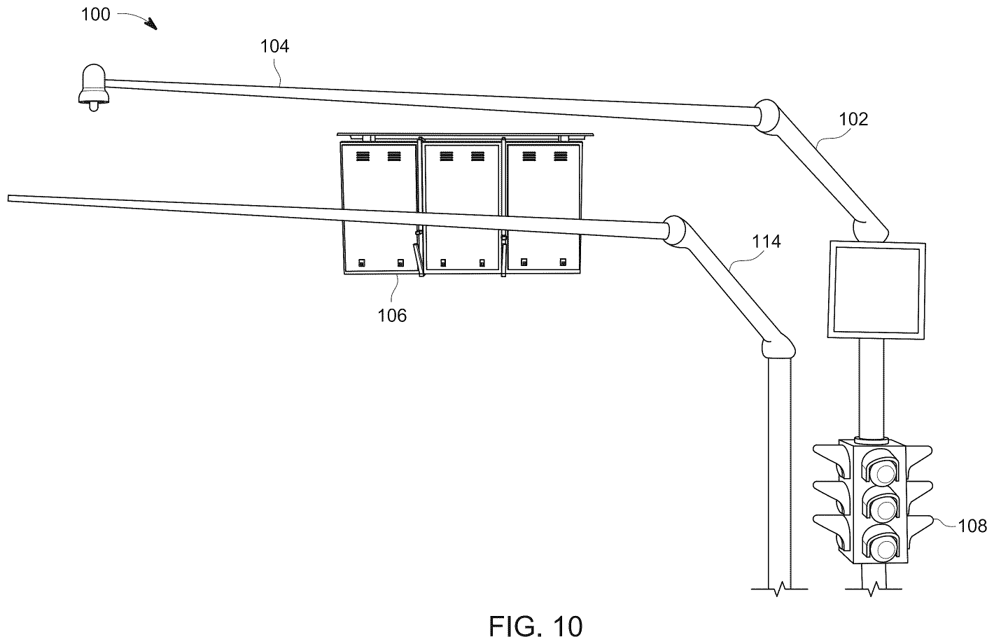

FIGS. 9 and 10 illustrate how the advertising display panel 106 can be mounted on either of two parallel post and beam structures at an intersection, providing flexibility in installation.

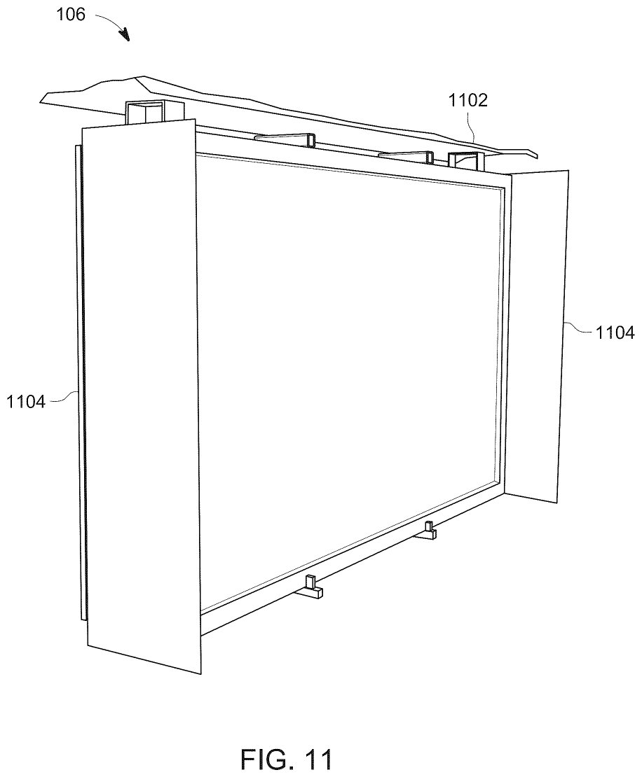

FIG. 11 shows a close-up view of the advertising display panel 106 with an overhanging cover 1102 and side panels 1104. These elements help protect the display from weather and improve visibility by reducing glare.

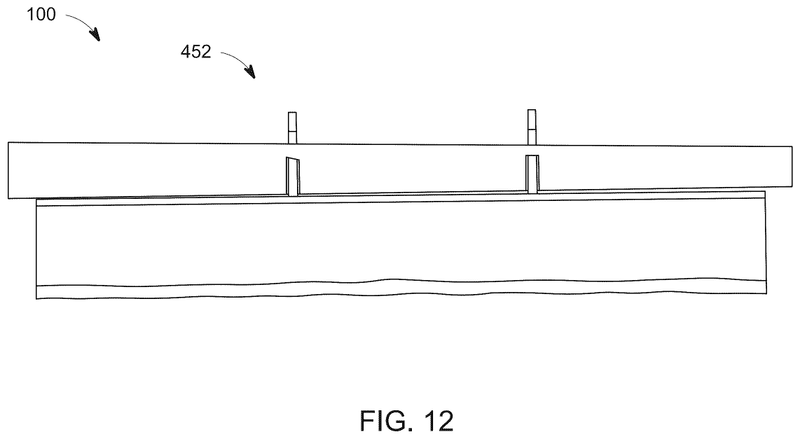

FIG. 12 provides a top-down view of the advertising display panel 106 mounted on a beam 104, showing how the overhanging cover 1102 extends beyond the display screen.

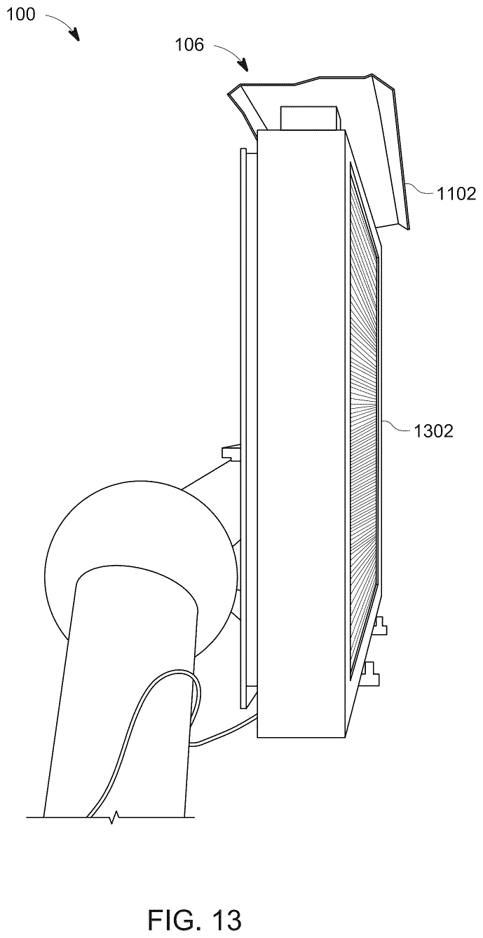

FIG. 13 illustrates a side view of the advertising display panel 106 attached to a beam 104, showing the overhanging cover 1102, display screen 1302, and rear mounting hardware 202.

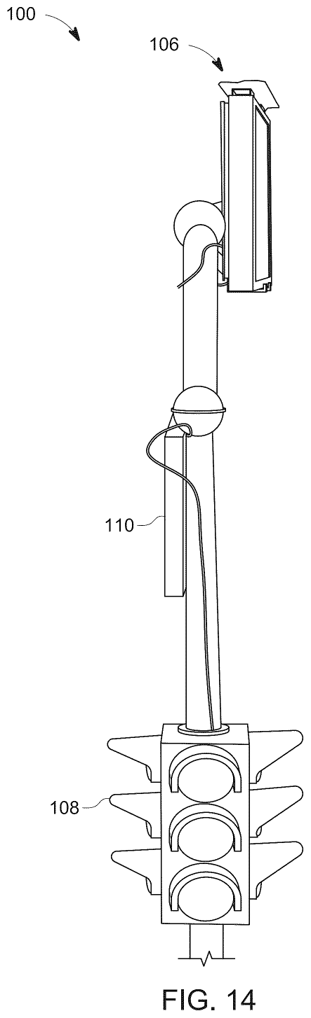

FIG. 14 shows a full side view of a traffic signal post 102 and beam 104 structure with the advertising display panel 106, signal control box 110, and traffic signal 108 all visible.

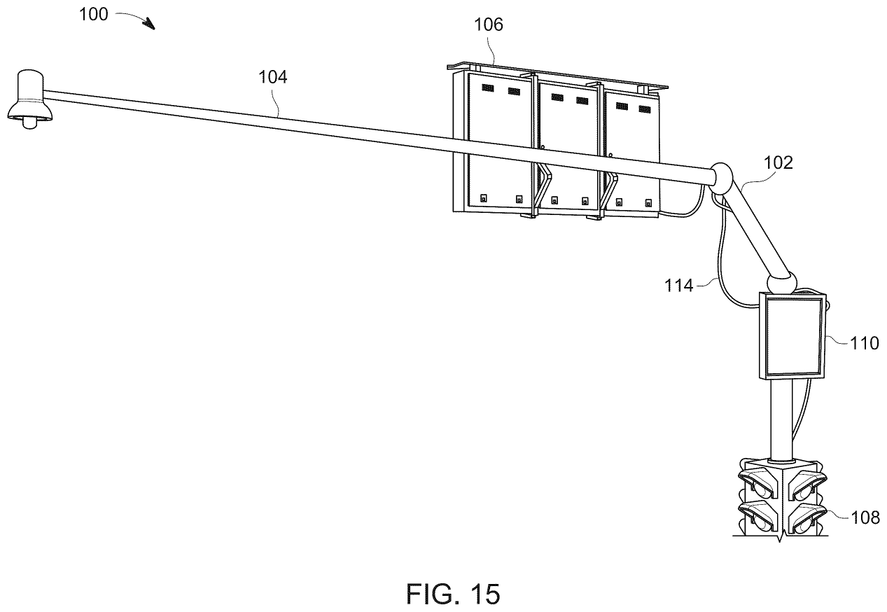

FIG. 15 provides a rear view of the advertising display panel 106, showing air vents 1502 for cooling and the metal rods 1504 used to secure the panel to the beam.

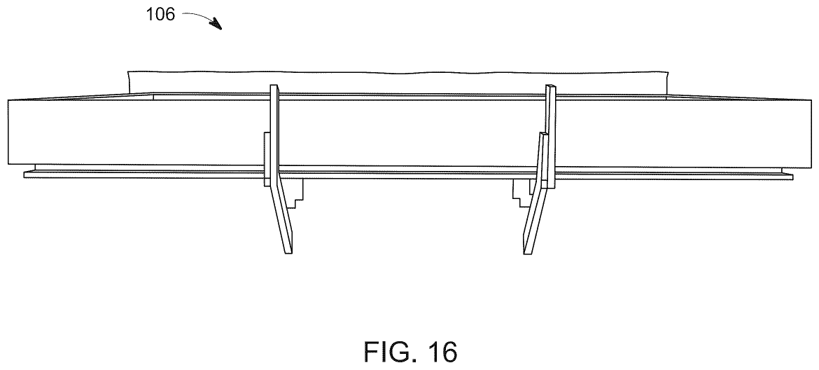

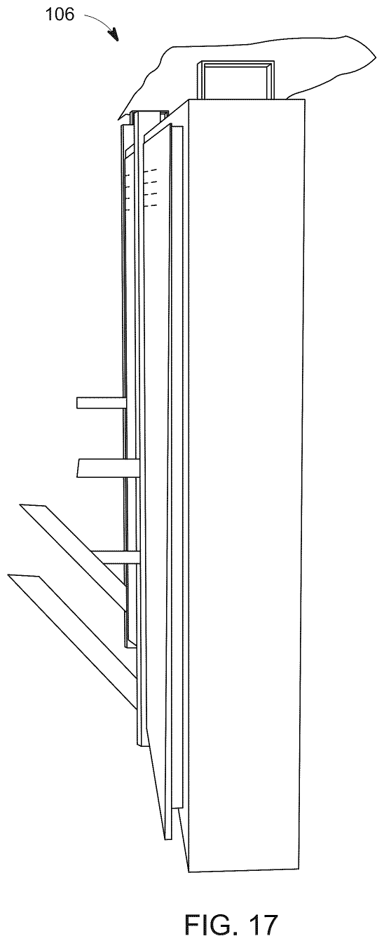

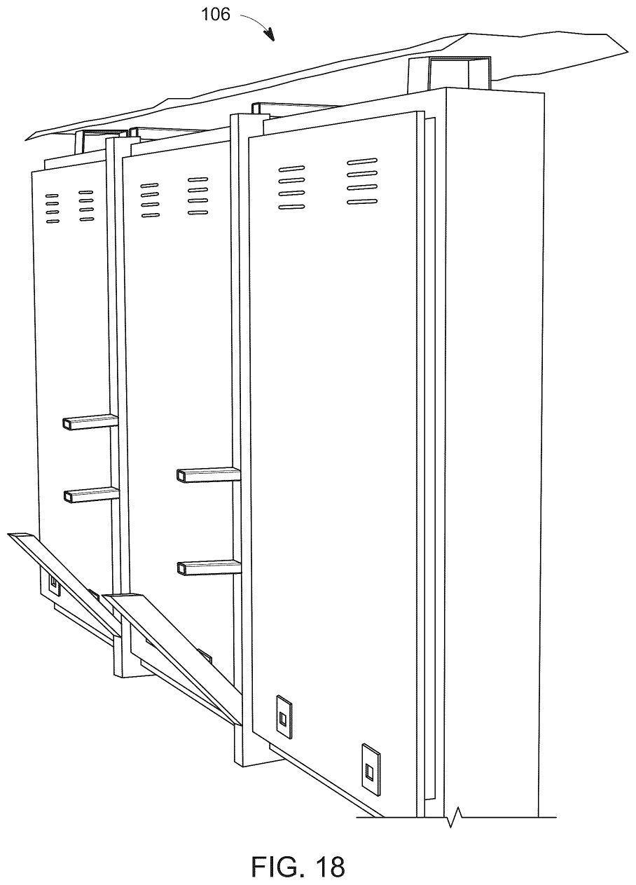

FIGS. 16-18 show various views of the mounting hardware used to attach the advertising display panel 106 to a traffic signal beam.

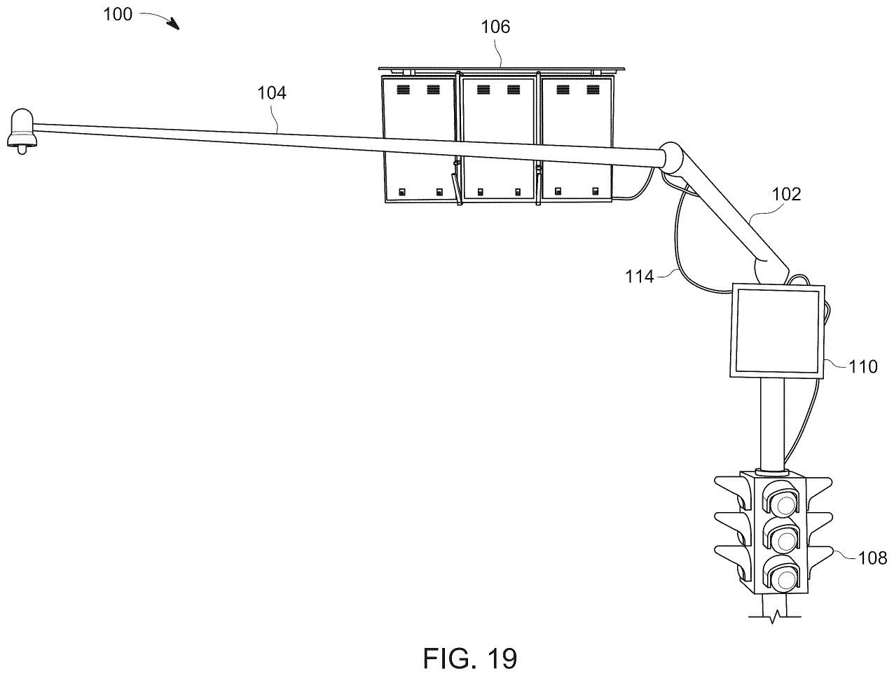

FIG. 19 provides another rear view of a complete traffic signal structure with the advertising display panel 106 mounted on the beam 104.

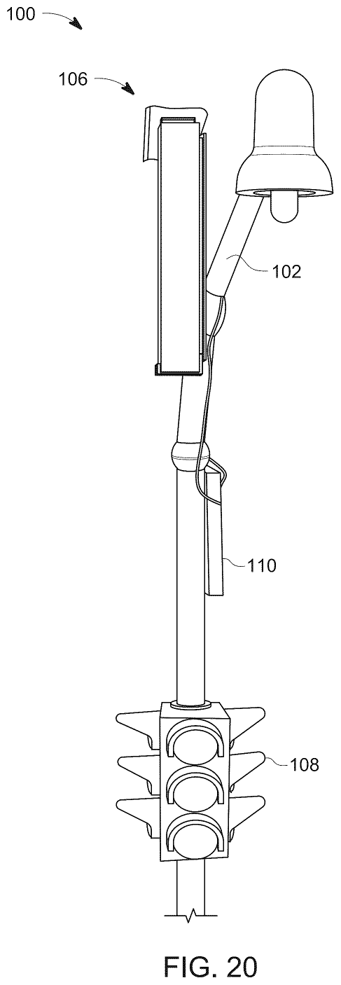

FIG. 20 shows a side view of the complete structure as it would appear to someone standing across the street at a crosswalk.

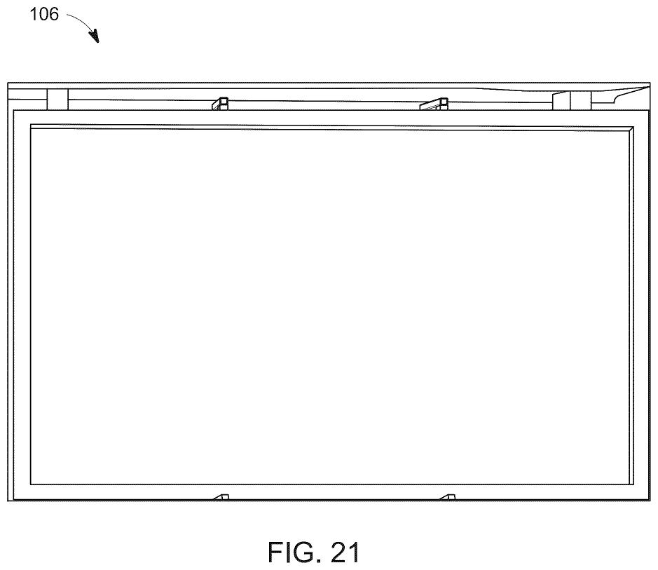

FIG. 21 illustrates a front view of just the advertising display panel 106.

In operation, the smart environmental advertising system displays advertisements on the advertising display panel 106 when the associated traffic signal 108 turns red. The control motherboard 112 receives a signal from the signal control box 110 indicating that the light has turned red. It then activates the display panel 106 to show pre-programmed advertising content. When the signal control box 110 indicates the light is turning green, the motherboard 112 immediately deactivates the display panel 106.

The advertising content can be managed remotely via an internet-connected management system. This allows advertisers to upload new content and schedule campaigns across multiple intersections from a central location. The system may use LED, LCD, or plasma display technology suitable for outdoor use in various weather conditions. In embodiments with a camera 702 or motion sensors, the system can detect the presence of vehicles or pedestrians and only activate displays when potential viewers are present. This helps conserve energy when traffic is light.

The smart environmental advertising system provides several advantages over traditional outdoor advertising. By coordinating displays with traffic signal timing, it reaches a captive audience of drivers and passengers waiting at red lights. The system makes productive use of wait times that would otherwise be wasted. By turning off displays when lights turn green, it avoids creating distractions when drivers need to focus on traffic. The weatherproof design and protective covers allow the system to operate reliably in various outdoor conditions. The flexible mounting options enable installation at a wide range of intersections, either on existing traffic signal structures or separate posts. The remote management capabilities allow for efficient operation of large networks of displays across a city or region. Advertising content can be quickly updated to reflect time-sensitive promotions or emergency public service announcements.

It should be understood that the embodiments described herein are exemplary and that a person skilled in the art may make many variations and modifications without departing from the spirit and scope of the disclosure. All such variations and modifications are intended to be included within the scope of the disclosure as defined in the appended claims.

While illustrative embodiments of the invention have been shown and described, variations and alternative embodiments may occur to those skilled in the art. Such variations and alternative embodiments may be made without departing from the scope of the invention as defined in the claims.

As used in this specification and the appended claims, the singular forms “a” and “an” indicate a single element, while “the” may refer back to single or plural referents. Unless defined otherwise, all technical and scientific terms used herein have the same meaning as commonly understood by one of ordinary skill in the art to which the disclosure pertains.

The above detailed description of exemplary and preferred embodiments is presented for the purposes of illustration and disclosure in accordance with the requirements of the law. It is intended to be exemplary but not exhaustive, and is not intended to limit the invention to the precise forms described, but only to enable others skilled in the art to understand how the invention may be suited for a particular use of implementation. No limitation is intended by the description of exemplary embodiments which may have included tolerances, feature dimensions, specific operating conditions, engineering specifications, or the like, and which may vary between implementations or with changes to the state of the art, and no such limitation should be implied therefrom.

Applicant has made this disclosure with respect to the current state of the art, but also contemplates advancements and that adaptations in the future may take into consideration those advancements in accordance with the then current state of the art. It is intended that the scope of the invention be defined by the Claims as written and equivalents as applicable. Reference to a claim element in the singular is not intended to mean “one and only one” unless explicitly so stated. No claim element herein is intended to be construed under the provisions of 35 U.S.C. 112(f), unless the element is expressly recited using the exact phrase “means for . . . ” and no method or process step herein is to be construed under the provisions of 35 U.S.C. section 112(f) unless the step, or steps, are expressly recited using the exact phrase “step(s) for . . . ”.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior present disclosure. Further, the dates of publication provided herein can be different from the actual publication dates, which can require independent confirmation.

The patentable scope of the present disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Insofar as the description above and the accompanying drawing disclose any additional subject matter that is not within the scope of the claims below, the disclosures are not dedicated to the public and the right to file one or more applications to claims such additional disclosures is reserved.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

It should be understood that the above-described embodiments are illustrative of only a few of the possible specific embodiments which can represent applications of the principles of the present disclosure. Numerous and varied other arrangements can be readily devised by those skilled in the art without departing from the spirit and scope of the disclosure. While specific embodiments of the invention have been described and illustrated, such embodiments should be considered illustrative of the invention only and not as limiting the invention as construed in accordance with the accompanying claims.

What is claimed is:

1. A smart environmental advertising system comprising:
a digital display screen;
a mounting structure for attaching the digital display screen in proximity to a traffic signal;
a control unit electrically connected to the digital display screen and to a traffic signal control system; and
a remote management system for uploading advertising content to the digital display screen;
wherein the control unit is configured to:
receive a signal from the traffic signal control system indicating that an associated traffic signal has turned red;
in response to receiving the signal, activate the digital display screen to display advertising content;
receive a signal from the traffic signal control system indicating that the associated traffic signal is turning green; and
in response to receiving the signal that the traffic signal is turning green, deactivate the digital display screen.

2. The system of claim 1, wherein the mounting structure attaches the digital display screen to a beam supporting the traffic signal.

3. The system of claim 1, wherein the mounting structure comprises a separate post and beam located within 10 feet of the traffic signal.

4. The system of claim 1, further comprising a motion sensor, wherein the control unit is further configured to:
receive data from the motion sensor indicating the presence or absence of vehicles or pedestrians; and
activate or deactivate the digital display screen based on the received motion sensor data.

5. The system of claim 1, wherein the digital display screen comprises a weatherproof LED, LCD, or plasma display.

6. The system of claim 1, wherein the digital display screen comprises an overhanging cover and side panels to protect the screen from weather and reduce glare.

7. The system of claim 1, wherein the remote management system is configured to allow scheduling of advertising campaigns across multiple intersections from a central location.

8. The system of claim 1, further comprising speakers for playing audio content in coordination with visual content on the digital display screen.

9. A method for environmental advertising, comprising:
mounting a digital display screen in proximity to a traffic signal;
electrically connecting a control unit to the digital display screen and to a traffic signal control system;
receiving, at the control unit, a signal from the traffic signal control system indicating that the traffic signal has turned red;
in response to receiving the signal, activating the digital display screen to display advertising content;
receiving, at the control unit, a signal from the traffic signal control system indicating that the traffic signal is turning green; and
in response to receiving the signal that the traffic signal is turning green, deactivating the digital display screen.

10. The method of claim 9, further comprising:
receiving motion sensor data indicating the presence or absence of vehicles or pedestrians; and
activating or deactivating the digital display screen based on the received motion sensor data.

11. The method of claim 9, further comprising uploading advertising content to the digital display screen via a remote management system.

12. The method of claim 11, further comprising scheduling advertising campaigns across multiple intersections from a central location using the remote management system.

13. The method of claim 9, wherein mounting the digital display screen comprises attaching the screen to a beam supporting the traffic signal.

14. The method of claim 9, wherein mounting the digital display screen comprises installing the screen on a separate post and beam located within 10 feet of the traffic signal.

15. The method of claim 9, further comprising playing audio content via speakers in coordination with visual content on the digital display screen.

16. A traffic signal structure comprising:
a vertical posta vertical post;
a horizontal beam attached to the vertical post;
a traffic signal mounted on the vertical post;
a digital display screen mounted on the horizontal beam; and
a control unit electrically connected to the digital display screen and to a traffic signal control system;
wherein the control unit is configured to:
receive a signal from the traffic signal control system indicating that the traffic signal has turned red;
in response to receiving the signal, activate the digital display screen to display advertising content;
receive a signal from the traffic signal control system indicating that the traffic signal is turning green; and
in response to receiving the signal that the traffic signal is turning green, deactivate the digital display screen.

17. The traffic signal structure of claim 16, further comprising a motion sensor, wherein the control unit is further configured to:
receive data from the motion sensor indicating the presence or absence of vehicles or pedestrians; and
activate or deactivate the digital display screen based on the received motion sensor data.

18. The traffic signal structure of claim 16, wherein the digital display screen comprises a weatherproof LED, LCD, or plasma display.

19. The traffic signal structure of claim 16, wherein the digital display screen comprises an overhanging cover and side panels to protect the screen from weather and reduce glare.

20. The traffic signal structure of claim 16, further comprising speakers for playing audio content in coordination with visual content on the digital display screen.
